(19) United States
(12) Patent Application Publication
(10) Pub. No.: US 2025/0390779 A1
(43) Pub. Date: Dec. 25, 2025

(54) AUTOMATIC COMPILATION OF QUBOS

(71) Applicant: Dell Products L.P., Round Rock, TX (US)

(72) Inventors: Brendan Burns Healy, Haddonfield, NJ (US); Saul Reyna, Malden, MA (US); George McGurkin, Baltimore, MD (US)

(21) Appl. No.: 18/752,314

(22) Filed: Jun. 24, 2024

(51) Int. Cl. G06N 10/60; G06N 10/20

(52) U.S. Cl. CPC G06N 10/60; G06N 10/20

(57) ABSTRACT

Techniques for generating a QUBO from an optimization problem's specification are disclosed. A service accesses the optimization problem and the specification. The specification declares parameters that are structured to facilitate subsequent compilation of an executable QUBO problem. The specification is organized in accordance with a first format. The service parses the specification to identify the parameters. The service generates a QUBO problem using the parsed parameters. The QUBO problem is organized in accordance with a second format. The service receives output from the quantum computing engine. The output corresponds to a solution to the QUBO problem and is organized in accordance with a third format. The service converts the output into a new output that is organized in accordance with either the first format or a fourth format.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to improved techniques for solving optimization problems. More particularly, at least some embodiments relate to systems, hardware, software, computer-readable media, and methods for automatically generating a QUBO from an optimization problem's specifications in a way that abstracts the complexity away from the end user.

### BACKGROUND

“QUBO” stands for “Quadratic Unconstrained Binary Optimization,” which is a kind of format used to facilitate combinatorial optimization for machine learning problems. Many real-world problems can be encoded in this format. Stated differently QUBO is a particular way to encode an optimization problem (i.e. a way to mathematically represent the optimization problem).

The QUBO format typically includes a single, multi-variable quadratic polynomial called the Hamiltonian “Q.” Typically, the objective with regard to Q is to minimize its value. The QUBO format has been popularized in part by the advent of Quantum Annealing (QA), which tries to interpolate between (i) a static problem-independent Hamiltonian Ho for which the ground state can be efficiently prepared and (ii) a final Hamiltonian whose ground state yields the desired answer. The QA system linearly interpolates between Ho and Hf to equal Q. The system is manipulated in the manner of leveraging a quantum tunneling effect that helps the system move closer to the ground state. There also exists digital (i.e. non-quantum) and simulated annealers, as well as classical solvers that evaluate QUBOs without inspiration from the annealing schema.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture that automatically generates a QUBO from an optimization problem's specification in a way that abstracts the complexity away from the end user.

FIG. 2 illustrates a flowchart for generating a QUBO.

FIG. 3 illustrates an example computer system that can be configured to perform any of the disclosed operations.

### DETAILED DESCRIPTION

Solving a combinatorial problem using annealing solutions, which are a kind of analog computing tool, often involves converting the problem into the QUBO format. This conversion relies on knowledge of highly specific tools that have their own specific methods and objects which are often not broadly applicable for other uses.

By way of further detail, because of the stringent way in which quantum annealers operate, they are typically structured in a manner so as to receive problems that have been formatted in a specific manner. There is a great amount of context and knowledge that is often gathered by an end user to make use of this format. Some packages, such as PyQUBO have been developed to make this collection easier, but even using these modules often requires a significant investment of time and skill.

Thus, one problem with the traditional technology is how can the QUBO formulation problem be made simpler, such as by abstracting as much away from the end user as possible. In other words, it is desirable to go from a user defined problem specification to compiled QUBO in the least amount of time, even for developers with no experience in annealing solvers. Thus, it is desirable to create an improved framework to enable the QUBO format to be broadly usable without having to have an intrinsic understanding of the underlying specific tools and knowledge that implement QUBO.

The disclosed embodiments bring about numerous benefits, advantages, and practical applications to quantum computing. In some aspects, the disclosed embodiments beneficially define a solution that, instead of using the above described tools directly, a user can now create an abstracted form of the problem by declaring the problem's variables and constraints, which can then be used as input for an algorithmic generation of the QUBO for the annealer. This user defined “specification” provides a structured, tool-agnostic platform for a user and is more intuitive for the user. For instance, the specification can be structured in a human-readable format (e.g., perhaps a standardized syntax format or perhaps a natural language format) that allows users to avoid having to invest time to learn the usage and documentation of some of the narrower technical tools. Accordingly, these and numerous other benefits will now be described in more detail throughout the remaining portions of this disclosure.

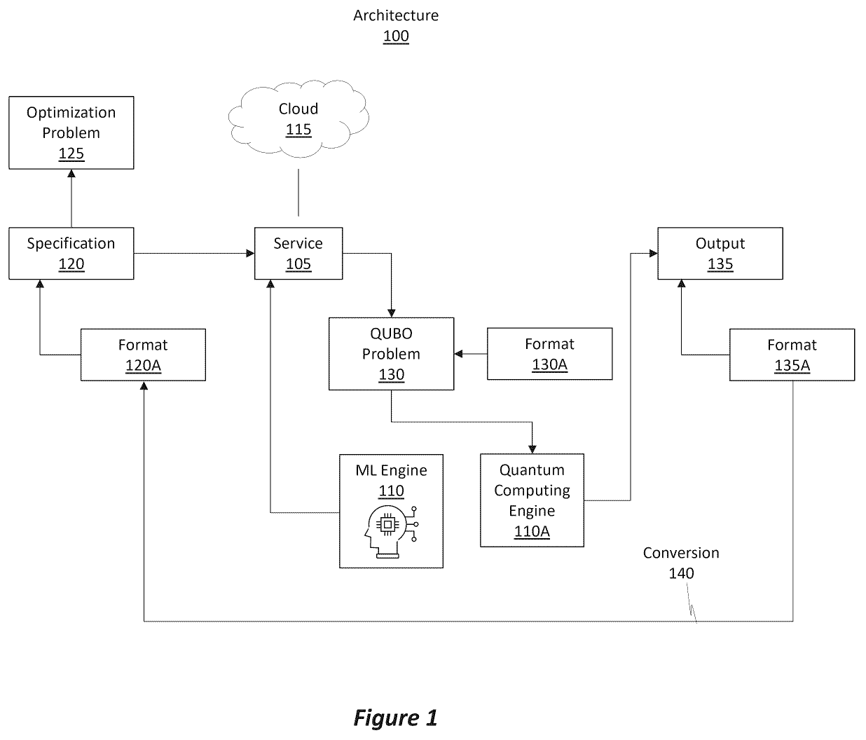

Attention will now be directed to FIG. 1, which illustrates an example architecture 100 in which the disclosed principles may be employed. Architecture 100 shows a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine (e.g., ML engine 110). The ML engine 110 enables service 105 to operate even when faced with a randomization factor. Typically, ML inferencing is separate from quantum computation. Service 105 can help facilitate the quantum computation, however.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 115 environment. In some implementations, service 105 is a local service operating on a local device. In some implementations, service 105 is a hybrid service that includes a cloud component operating in the cloud and a local component operating on a local device. These two components can communicate with one another.

Service 105 is generally directed to facilitating techniques for abstracting away the complexity of compiling a set of constraints, variables, and objectives into a QUBO problem. Service 105 thus enables users to transform these optimization problems into a human-readable representation without the need of the user to understand the more technical details of a QUBO problem's format.

For example, in FIG. 1, service 105 accesses a specification 120 associated with a given optimization problem 125. The specification 120 can define the parameters mentioned above (e.g., the constraints, variables, objective functions, etc.). The format 120A of the specification can vary. For instance, in some implementations, the format 120A is a pre-defined format that involves specific formatting and syntax (i.e. a standardized syntax format), but this formatting and syntax can be designed in a manner so as to be more intuitive and readable than traditional QUBO syntax. In some implementations, format 120A can generally be in a natural language format. Thus, in accordance with the disclosed principles, the format 120A can be of any recognized type, and the format 120A is an example of a “first” format.

Optionally, the specification 120 can be defined using a .CSV file. In some cases, the specification 120 can be defined using any type of word processing document. In some cases, the specification 120 can be defined using a spreadsheet, a .txt file, or any type of document that can record text data. In some scenarios, the specification 120 can be populated by presenting a user interface to the user, where the interface includes form fillable fields that the user can enter data so as to generate the specification 120.

In order to compile a QUBO, it was often the case that a user needed knowledge about existing tools that facilitate this compilation process (such as Python's PyQUBO library) and additional time investment in order to understand the library's usage. The disclosed solutions to this problem use a higher level, yet still structured specification (e.g., specification 120) to define the optimization problem. The structure of the specification 120 enables service 105 to parse out details about the underlying data in order to extract the relevant information, such as, constraints, variables, objective functions, and so on, which are used to compile an executable QUBO problem.

In some implementations, these processes can be implemented as a web application. The web application allows users to upload their structured specifications of an optimization problem (e.g., optimization problem 125) and execute this abstracted and simplified process of QUBO compilation in a manner such that the expensive work of compilation is offloaded to a remote worker node dedicated for QUBO simulation.

FIG. 1 shows how service 105 is able to receive the specification 120 and identify and parse out the relevant information, as described above. Subsequently, service 105 is able to generate a QUBO problem 130 having a different format 130A than the format 120A of the specification 120. The format 130A can be viewed as being a “second” format, which is a QUBO format. The QUBO format (i.e. the format 130A) is typically a square matrix format or a binary format.

In some implementations, service 105 can rely on a re-entrant neural network or any type of large language model to facilitate the format conversion process. For instance, the LLM can be used to convert the key terms (e.g., parameters, variables, constraints, etc.) defined in the specification 120 into the format that is usable by the quantum accelerators of a quantum computing engine 110A. In some scenarios, other types of artificial intelligence (AI) ML models are used to facilitate the conversion process. In some scenarios, particularly where a specific syntax and structure is used as the format for the specification 120, the conversion process can happen in a “dumb” manner without reliance on machine learning. It should also be noted how the terms defined in the specification 120 need not necessarily be binary or unconstrained.

The QUBO problem 130 is then fed as input to a quantum computing engine 110A. The quantum computing engine 110A then generates output 135, which is a solution to the QUBO problem 130. Notably, the output 135 from the quantum computing engine 110A will be in yet another format 135A. The format 135A can be viewed as being a “third” format, which is typically a binary format. That is, the output 135 is typically structured as a bit string of ones and zeros.

Service 105 can then perform a conversion 140 operation on the output 135 to convert the format 135A back to the original format 120A used by the specification 120 or, potentially, to a fourth format. In most scenarios, the format 135A is converted to the same format as format 120A. In some scenarios, service 105 can convert the format 135A to yet a different format (i.e. a “fourth” format). As an example, suppose the format 120A is a specific, pre-defined syntax structure format. It might be desirable to format the final output in a natural language format. Thus, in some scenarios, service 105 performs a first re-formatting operation to convert format 120A to format 130A. Service 105 may then perform another re-formatting operation to convert format 135A either back to format 120A or to a fourth format, such as perhaps a natural language format.

For example, if the format 120A is a predefined syntax and structure type of format, then service 105 can convert format 135A, which is typically a binary format, back to the predefined syntax and structure type of format. Similarly, if the format 120A is a natural language format, then service 105 can convert format 135A back to the natural language format.

An additional example will be helpful. Suppose the input constraints in the specification 120 include the following data:

$$apples + bananas = total\_fruit$$

Service 105 can use string parsing to identify the different variables, which include “apples”, “bananas”, and “total_fruit”. Service 105 can perform this parsing operation by splitting strings based on common mathematical terms (e.g., +, −, =, *, /, etc.) or other recognized syntax. Then, service 105 can extract the nature, semantics, or meaning of the constraints. Service 105 then reformulates the linear constraints into a quadratic penalty on the Hamiltonian. The example constraint becomes the penalty:

$$USER\_SUBMITTED \_WEIGHTING * ( apples + bananas - total\_fruit ) ** 2$$

Notice, in this example, the penalty is always positive (making the solution less attractive to the QUBO solver) and grows quadratically the more the constraint is failed in either direction. Inequality constraints can be handled by the introduction of slack variables. The objective expression can also be added directly to the Hamiltonian, such as perhaps using a weighting multiplier.

In some implementations, the embodiments can avoid sending the QUBO problem 130 to an actual quantum accelerator. Instead, some embodiments send the QUBO problem to a simulated annealing engine, which is tasked with simulating the processes of the quantum accelerator. If a situation arises where the format for the simulated annealing engine is different from the format used by the quantum accelerator, then the embodiments are dynamic enough to enable the use of the simulated annealing engine's format.

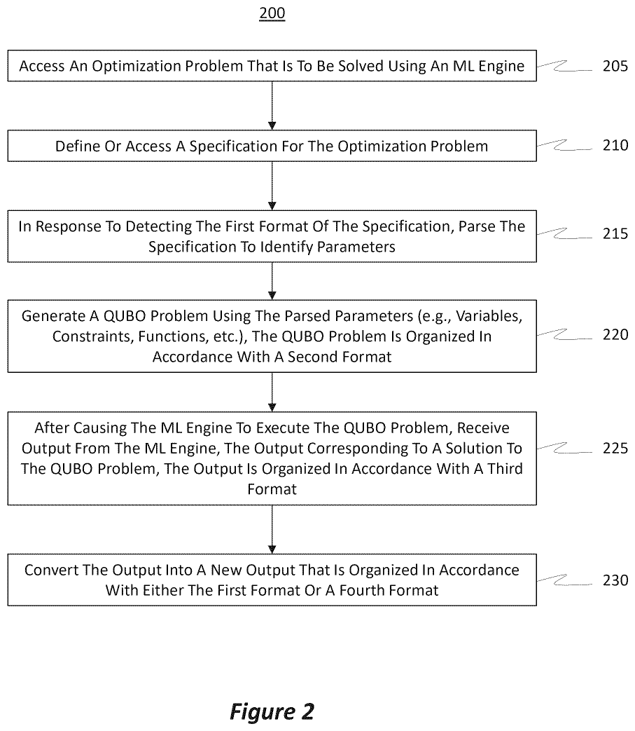

Attention will now be directed to FIG. 2, which illustrates a flowchart of an example method 200 for automatically generating a QUBO from an optimization problem's specifications (e.g., parameters, constraints, objectives, variables, etc.) in a way that abstracts the complexity away from the end user. Method 200 can be implemented within architecture 100 of FIG. 1. Also, method 200 can be performed by service 105.

Method 200 includes an act (act 205) of accessing an optimization problem that is to be solved using a machine learning (ML) engine. The quantum computing engine 110A mentioned previously may include one or more quantum accelerators.

Act 210 includes defining or accessing a specification for the optimization problem. The specification declares parameters that are structured to facilitate subsequent compilation of an executable QUBO problem that is executable by the quantum computing engine 110A. The parameters can include one or more variables, one or more constraints, and/or one or more objective functions. Notably, the specification is organized in accordance with a first format. In response to detecting the first format, act 215 includes parsing the specification to identify the parameters.

Act 220 then includes generating a QUBO problem using the parameters (e.g., variable, constraints, functions, etc.). The QUBO problem is organized in accordance with a second format that is different than the first format.

After causing the quantum computing engine 110A to execute the QUBO problem, act 225 includes receiving output from the quantum computing engine 110A. The output corresponds to a solution to the QUBO problem. The output is organized in accordance with a third format. The quantum computing engine 110A can execute the QUBO problem using the one or more quantum accelerators.

Act 230 includes converting the output, which is organized in accordance with the third format, into a new output that is organized in accordance with either the first format or a fourth format.

The first format can be one of a standardized syntax format or a natural language format or potentially any other human readable format. In some scenarios, the second format is one of: a square matrix format, a binary format, or a QUBO format. The third format can be a binary format. The fourth format can be of any type; often, the fourth format is a natural language format.

The process of parsing the specification can be performed using a large language model or any type of re-entrant neural network. Optionally, the new output can be organized in accordance with the fourth format. The first format can be a standardized syntax format, and the fourth format can be a natural language format. As another option, the new output can be organized in accordance with the first format, which can be a natural language format or a standardized syntax format.

By performing the disclosed operations, a user can now be abstracted away from having to use the complex QUBO formatting requirements. Furthermore, the disclosed service can operate as an intermediary or a proxy between the user and the quantum accelerators. Now, the user can entirely interact with the service, and the service can re-formulate the user's input into a form that is usable by the quantum accelerators. Similarly, the service can re-formulate the output of the quantum accelerators into a format that is usable by the user. Accordingly, the disclosed techniques provide a standardized, platform agnostic technique for generating QUBO problem statement code. Advantageously, the disclosed embodiments can convert a set of linear constraints and integer parameters in the specification from a first format (e.g., the specification's format) into a format that is directly digestible by the quantum accelerators.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

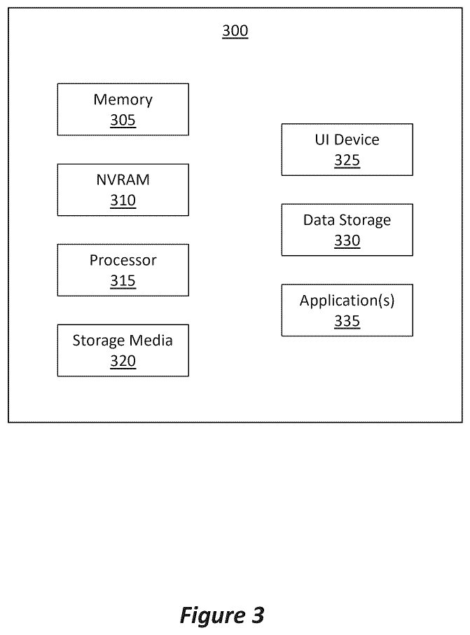

With reference briefly now to FIG. 3, any one or more of the entities disclosed, or implied, by the Figures and/or elsewhere herein, may take the form of, or include, or be implemented on, or hosted by, a physical computing device, one example of which is denoted at 300. Also, where any of the aforementioned elements comprise or consist of a virtual machine (VM), that VM may constitute a virtualization of any combination of the physical components disclosed in FIG. 3.

In the example of FIG. 3, the physical computing device 300 includes a memory 305 which may include one, some, or all, of random access memory (RAM), non-volatile memory (NVM) 310 such as NVRAM for example, read-only memory (ROM), and persistent memory, one or more hardware processors 315, non-transitory storage media 320, UI device 325, and data storage 330. One or more of the memory 305 of the physical computing device 300 may take the form of solid-state device (SSD) storage. Also, one or more applications 335 may be provided that comprise instructions executable by one or more hardware processors 315 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 300 may also be representative of an edge system, a cloud-based system, a datacenter or portion thereof, or other system or entity.

The disclosed embodiments can be implemented in numerous different ways, as described in the various different clauses recited below.

Clause 1. A method comprising: accessing an optimization problem that is to be solved using a machine learning (ML) engine, which includes one or more quantum accelerators; defining or accessing a specification for the optimization problem, wherein the specification declares parameters that are structured to facilitate subsequent compilation of an executable QUBO problem that is executable by the quantum computing engine, wherein the specification is organized in accordance with a first format; in response to detecting the first format, parsing the specification to identify the parameters; generating a QUBO problem using the parameters, wherein the QUBO problem is organized in accordance with a second format that is different than the first format; after causing the quantum computing engine to execute the QUBO problem, receiving output from the quantum computing engine, the output corresponding to a solution to the QUBO problem, wherein the output is organized in accordance with a third format; and converting the output, which is organized in accordance with the third format, into a new output that is organized in accordance with the first format.

Clause 2. The method of any of the preceding clauses, wherein the first format is a standardized syntax format.

Clause 3. The method of any of the preceding clauses, wherein the first format is a natural language format.

Clause 4. The method of any of the preceding clauses, wherein the second format is a square matrix format.

Clause 5. The method of any of the preceding clauses, wherein the second format is one of: a square matrix format, a binary format, or a QUBO format.

Clause 6. The method of any of the preceding clauses, wherein the third format is a binary format.

Clause 7. The method of any of the preceding clauses, wherein parsing the specification is performed using a large language model.

Clause 8. A method comprising: accessing an optimization problem that is to be solved using a machine learning (ML) engine; defining or accessing a specification for the optimization problem, wherein the specification declares a variable, a constraint, and an objective function that are structured to facilitate subsequent compilation of an executable QUBO problem that is executable by the quantum computing engine, wherein the specification is organized in accordance with a first format; in response to detecting the first format, parsing the specification to identify at least the variable, the constraint, and the objective function; generating a QUBO problem using the parsed variable, constraint, and objective function, wherein the QUBO problem is organized in accordance with a second format that is different than the first format; after causing the quantum computing engine to execute the QUBO problem, receiving output from the quantum computing engine, the output corresponding to a solution to the QUBO problem, wherein the output is organized in accordance with a third format; and converting the output, which is organized in accordance with the third format, into a new output that is organized in accordance with either the first format or a fourth format.

Clause 9. The method of any of the preceding clauses, wherein the first format is one of a standardized syntax format or a natural language format.

Clause 10. The method of any of the preceding clauses, wherein the second format is one of a square matrix format or a binary format.

Clause 11. The method of any of the preceding clauses, wherein the third format is a binary format.

Clause 12. The method of any of the preceding clauses, wherein the new output is organized in accordance with the fourth format, wherein the first format is a standardized syntax format, and wherein the fourth format is a natural language format.

Clause 13. The method of any of the preceding clauses, wherein parsing the specification is performed using a large language model.

Clause 14. The method of any of the preceding clauses, wherein the second format is a QUBO format.

Clause 15. A computer system comprising: one or more processors; and one or more hardware storage devices that store instructions that are executable by the one or more processors to cause the computer system to: access an optimization problem that is to be solved using a machine learning (ML) engine; define or access a specification for the optimization problem, wherein the specification declares parameters that are structured to facilitate subsequent compilation of an executable QUBO problem that is executable by the quantum computing engine, wherein the specification is organized in accordance with a first format; in response to detecting the first format, parse the specification to identify the parameters; generate a QUBO problem using the parsed parameters, wherein the QUBO problem is organized in accordance with a second format that is different than the first format; after causing the quantum computing engine to execute the QUBO problem, receive output from the quantum computing engine, the output corresponding to a solution to the QUBO problem, wherein the output is organized in accordance with a third format; and convert the output, which is organized in accordance with the third format, into a new output that is organized in accordance with either the first format or a fourth format.

Clause 16. The computer system of any of the preceding clauses, wherein the first format is one of a standardized syntax format or a natural language format, wherein the second format is one of a square matrix format, a binary format, or a QUBO format, and wherein the third format is a binary format.

Clause 17. The computer system of any of the preceding clauses, the quantum computing engine executes the QUBO problem using a quantum accelerator.

Clause 18. The computer system of any of the preceding clauses, wherein parsing the specification is performed using a re-entrant neural network.

Clause 19. The computer system of any of the preceding clauses, wherein the new output is organized in accordance with the fourth format, wherein the first format is a standardized syntax format, and wherein the fourth format is a natural language format.

Clause 20. The computer system of any of the preceding clauses, wherein the new output is organized in accordance with the first format, which is a natural language format.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
accessing an optimization problem that is to be solved using a machine learning (ML) engine, which includes one or more quantum accelerators;
defining or accessing a specification for the optimization problem, wherein the specification declares parameters that are structured to facilitate subsequent compilation of an executable QUBO problem that is executable by a quantum computing engine, wherein the specification is organized in accordance with a first format;
in response to detecting the first format, parsing the specification to identify the parameters;
generating a QUBO problem using the parameters, wherein the QUBO problem is organized in accordance with a second format that is different than the first format;
after causing the quantum computing engine to execute the QUBO problem, receiving output from the quantum computing engine, the output corresponding to a solution to the QUBO problem, wherein the output is organized in accordance with a third format; and
converting the output, which is organized in accordance with the third format, into a new output that is organized in accordance with the first format.

2. The method of claim 1, wherein the first format is a standardized syntax format.

3. The method of claim 1, wherein the first format is a natural language format.

4. The method of claim 1, wherein the second format is a square matrix format.

5. The method of claim 1, wherein the second format is one of a binary format or a QUBO format.

6. The method of claim 1, wherein the third format is a binary format.

7. The method of claim 1, wherein parsing the specification is performed using a large language model.

8. A method comprising:
accessing an optimization problem that is to be solved using a machine learning (ML) engine;
defining or accessing a specification for the optimization problem, wherein the specification declares a variable, a constraint, and an objective function that are structured to facilitate subsequent compilation of an executable QUBO problem that is executable by a quantum computing engine, wherein the specification is organized in accordance with a first format;
in response to detecting the first format, parsing the specification to identify at least the variable, the constraint, and the objective function;
generating a QUBO problem using the parsed variable, constraint, and objective function, wherein the QUBO problem is organized in accordance with a second format that is different than the first format;
after causing the quantum computing engine to execute the QUBO problem, receiving output from the quantum computing engine, the output corresponding to a solution to the QUBO problem, wherein the output is organized in accordance with a third format; and
converting the output, which is organized in accordance with the third format, into a new output that is organized in accordance with either the first format or a fourth format.

9. The method of claim 8, wherein the first format is one of a standardized syntax format or a natural language format.

10. The method of claim 8, wherein the second format is one of a square matrix format or a binary format.

11. The method of claim 8, wherein the third format is a binary format.

12. The method of claim 8, wherein the new output is organized in accordance with the fourth format, wherein the first format is a standardized syntax format, and wherein the fourth format is a natural language format.

13. The method of claim 8, wherein parsing the specification is performed using a large language model.

14. The method of claim 8, wherein the second format is a QUBO format.

15. A computer system comprising:
one or more processors; and
one or more hardware storage devices that store instructions that are executable by the one or more processors to cause the computer system to:
access an optimization problem that is to be solved using a machine learning (ML) engine;
define or access a specification for the optimization problem, wherein the specification declares parameters that are structured to facilitate subsequent compilation of an executable QUBO problem that is executable by a quantum computing engine, wherein the specification is organized in accordance with a first format;
in response to detecting the first format, parse the specification to identify the parameters;
generate a QUBO problem using the parsed parameters, wherein the QUBO problem is organized in accordance with a second format that is different than the first format;
after causing the quantum computing engine to execute the QUBO problem, receive output from the quantum computing engine, the output corresponding to a solution to the QUBO problem, wherein the output is organized in accordance with a third format; and
convert the output, which is organized in accordance with the third format, into a new output that is organized in accordance with either the first format or a fourth format.

16. The computer system of claim 15, wherein the first format is one of a standardized syntax format or a natural language format, wherein the second format is one of a square matrix format, a binary format, or a QUBO format, and wherein the third format is a binary format.

17. The computer system of claim 15, the quantum computing engine executes the QUBO problem using a quantum accelerator.

18. The computer system of claim 15, wherein parsing the specification is performed using a re-entrant neural network.

19. The computer system of claim 15, wherein the new output is organized in accordance with the fourth format, wherein the first format is a standardized syntax format, and wherein the fourth format is a natural language format.

20. The computer system of claim 15, wherein the new output is organized in accordance with the first format, which is a natural language format.
